(19) United States
(12) Patent Application Publication
(10) Pub. No.: US 2016/0362996 A1
(43) Pub. Date: Dec. 15, 2016

(54) COMPONENT WHICH CAN BE SUBJECTED TO HOT GAS FOR A GAS TURBINE AND SEALING ARRANGEMENT HAVING SUCH A COMPONENT

(71) Applicant: SIEMENS AKTIENGESELLSCHAFT, München (DE)

(72) Inventors: Fathi Ahmad, Kaarst (DE); Ralf Müsgen, Essen (DE); Radan Radulovic, Bochum (DE); Marco Schüler, Essen (DE)

(73) Assignee: Siemens Aktiengesellschaft, Munich (DE)

(21) Appl. No.: 15/117,334

(22) PCT Filed: Feb. 13, 2015
(86) PCT No.: PCT/EP2015/053070

§ 371 Date: Aug. 8, 2016

(30) Foreign Application Priority Data
Feb. 14, 2014 (EP) 14155131.7

(51) Int. Cl. F01D 11/00; F01D 25/26; F01D 5/12

(52) U.S. Cl. CPC F01D 11/006; F01D 5/12; F01D 25/26; F05D 2220/32

(57) ABSTRACT

A component which can be subjected to hot gas for a gas turbine, the component having at least one wall, which includes a first surface as far as an edge, the first surface for delimiting a hot gas flow path of the gas turbine, and which includes a second surface, which adjoins the edge and is arranged transversely to the first surface. A groove for receiving a sealing element is arranged in the second surface and extends at least partially along the edge at a distance from the edge. The groove includes a groove base lying opposite the groove opening and two mutually facing side walls which adjoin the groove base and extend along the edge. At least one of the side walls has at least one groove-shaped recess.

### CROSS REFERENCE TO RELATED APPLICATIONS

This application is the US National Stage of International Application No. PCT/EP2015/053070 filed Feb. 13, 2015, and claims the benefit thereof. The International Application claims the benefit of European Application No. EP14155131 filed Feb. 14, 2014. All of the applications are incorporated by reference herein in their entirety.

### FIELD OF INVENTION

The invention relates to a component which can be subjected to hot gas for a gas turbine, having at least one wall—which comprises a first surface as far as an edge, wherein the first surface is intended for delimiting a hot gas flow path of the gas turbine, and—which comprises a second surface which adjoins the edge and is arranged transversely with respect to the first surface, wherein a groove provided for receiving a sealing element is arranged in the second surface and extends at least partially along the edge at a distance from the edge, and wherein the groove comprises a groove base opposite the groove opening and two mutually facing side walls which adjoin said groove face and extend along the edge.

### BACKGROUND OF INVENTION

Components of this type are known for forming a sealing arrangement from the prior art. For example, GB 2 195 403 A discloses two components of this type, the second surfaces of which lie opposite each other forming a gap, wherein the grooves which then likewise lie opposite each other accommodate a sealing element which very substantially blocks the gap against flow therethrough.

Thus, for example, EP 2 615 254 A2 proposes providing, in the sealing groove side wall arranged on the hot-gas side, ventilation grooves which can be combined to form groups and which taper from their bottom as far as their opening opening in the sealing groove side wall. The intention is therefore to achieve an improved cooling effect with simultaneously reduced wear.

In addition, it is known from EP 2 365 188 A1 also to arrange, uniformly distributed, respectively mutually opposite channels, which are connected to each other in pairs, for the conduction of cooling air in the two sealing groove side walls. The intention with said channels is for the sealing element sitting in the sealing grooves to be able to be sufficiently cooled.

Furthermore, EP 2 615 255 A1 and JP 2009/257281 A1 disclose sealing arrangements in which cooling air can be supplied to the sealing grooves by separate cooling air supply means opening therein.

However, it has turned out that, despite the known variants, sealing arrangements of this type may have a tendency to oxidation at certain points. The oxidation leads to a loss of material, and therefore the components, which are generally configured as turbine blades, can no longer be processed, and therefore the end of their surface life occurs prematurely. Firstly, this reduces the availability of a gas turbine equipped with these turbine blades and, secondly, this increases the waste rate of turbine blades which may need to be exchanged.

### SUMMARY OF INVENTION

It is therefore an object of the invention to provide a component which can be subjected to hot gas and the edges of which have less tendency to wear. It is a further object of the invention to provide a durable, comparatively oxidation-resistant and cost-effective sealing arrangement comprising two components which are each arranged in such a manner that the second side surfaces thereof lie opposite each other forming a gap, and into the mutually opposite grooves of which a sealing element is inserted for sealing the gap.

The object on which the invention is based is achieved with a component which can be subjected to hot gas and with a sealing arrangement in accordance with the features of the independent claims.

Further advantageous refinements are specified in the dependent claims.

According to the invention, in the case of the component which can be subjected to hot gas for a gas turbine, having at least one wall—which comprises a first surface as far as an edge, wherein the first surface is intended for delimiting a hot gas flow path of the gas turbine, and—which comprises a second surface which adjoins the edge and is arranged transversely with respect to the first surface, wherein a groove provided for receiving a sealing element is arranged in the second surface and extends at least partially along the edge at a distance from the edge, and wherein the groove comprises a groove base opposite the groove opening and two mutually facing side walls which adjoin said groove base and extend along the edge, of which side walls one of the two is arranged on the hot gas side and the other is arranged on the cold gas side and each have recesses, at least some of the recesses can be combined to form a group, the recesses of which are arranged in such a manner that two of said recesses of said group are arranged in the hot-gas-side side wall and are spaced apart from each other in such a manner that a further recess of said group, which recess is arranged in the cold-gas-side side wall, partially lies opposite each of the two hot-gas-side recesses.

The groove-shaped recesses in one side wall or in the two side walls serve as flow passages for cooling air and are advantageously located where the edges of the components are exposed to greater wear and oxidation. Consequently, the locally targeted blowing out of the cooling air quantity, which is predeterminable by the size of the recesses, reduces the thermal loading and improves the durability of the stressed area. At the same time, the recesses in the side walls of the groove reduce the quantity of component material which is to be cooled, which is why the groove-shaped recesses in the side walls constitute a technically more expedient solution than the sealing elements in GB 2 195 403 A, which, for their part, have slots at certain points for the passage of cooling air.

Since, in the sealing arrangement according to the invention, slots can be avoided in the sealing elements which are inserted in the grooves, the sealing elements are more durable than sealing elements with slots. As a result, the sealing arrangement according to the invention, in which at least one of the components, in particular the two components, are configured according to the invention and are arranged with respect to each other in such a manner that the second surfaces thereof lie opposite each other forming a gap and a sealing element is inserted into the mutually opposite grooves thereof for sealing the gap, achieves an overall longer service life. The sealing element is particularly then configured in the shape of a panel. That is to say, it is free from slots, recesses or tapered portions which are provided for the targeted conduction of cooling air.

The groove-shaped recesses of the side walls extend from the groove opening of the groove accommodating the sealing element as far as the groove base of the groove accommodating the sealing element.

According to a first advantageous development, each side wall has a plurality of groups of groove-shaped recesses in at least one longitudinal portion of the groove accommodating the sealing elements. By this means, groove-shaped recesses are provided both on the cold-gas side and on the hot-gas side of the side walls of the groove, through which recesses the coolant flowing therethrough can be conducted selectively to those positions which are particularly highly loaded thermally and/or corrosively.

An arrangement of this type can be produced in a particularly simple manner, for example by erosion, wherein the longer recesses are advantageously arranged on the cold-gas side. The recesses positioned more narrowly are then arranged on the hot-gas side, which permits a better and more uniform distribution of cooling air.

Furthermore, the groove has a region which is free from recesses and the longitudinal extent of which is greater than the longitudinal extent of an individual group.

In a development of the sealing arrangement, in each case at least one group of recesses is expediently provided in each of the mutually opposite grooves, said recesses being offset with respect to one another at least partially along the groove extent. The component according to the invention can be configured, for example, as turbine guide blades, as turbine rotor blades or as an annular segment. However, further use areas within the gas turbine are also conceivable, for example in the transition from a combustion chamber to an annular channel in which the blades of the turbine are arranged.

Overall, the invention therefore relates to a component which can be subjected to hot gas for a gas turbine, having at least one wall which comprises a first surface as far as an edge, wherein the first surface is intended for delimiting a hot gas flow path of the gas turbine, and which comprises a second surface which adjoins the edge and is arranged transversely with respect to the first surface, wherein a groove provided for receiving a sealing element is arranged in the second surface and extends at least partially along the edge at a distance from the edge, and wherein the groove comprises a groove base opposite the groove opening and two mutually facing side walls which adjoin said groove base and extend along the edge, of which side walls one of the two is arranged on the hot gas side and the other is arranged on the cold gas side and each have recesses. In order to achieve good sealing while maintaining defined cooling of the gap-forming components, it is proposed that at least some of the recesses can be combined to form a group, the recesses of which are arranged in such a manner that two of said recesses of said group are arranged in the hot-gas-side side wall and are spaced apart from each other in such a manner that a further recess of said group, which recess is arranged in the cold-gas-side side wall, partially lies opposite each of the two hot-gas-side recesses.

### BRIEF DESCRIPTION OF THE DRAWINGS

Further advantages and features of the invention are specified with reference to a plurality of exemplary embodiments. In the figures:

FIG. 1 shows a side view of a turbine blade in the region of the platform with a groove for accommodating a sealing element, and

FIG. 2 shows the cross section through a sealing arrangement with two directly adjacent components, the grooves of which, are according to the invention, lie directly opposite one another and in which a panel-shaped sealing element is arranged.

### DETAILED DESCRIPTION OF INVENTION

In all of the figures, identical features are provided with the same reference signs.

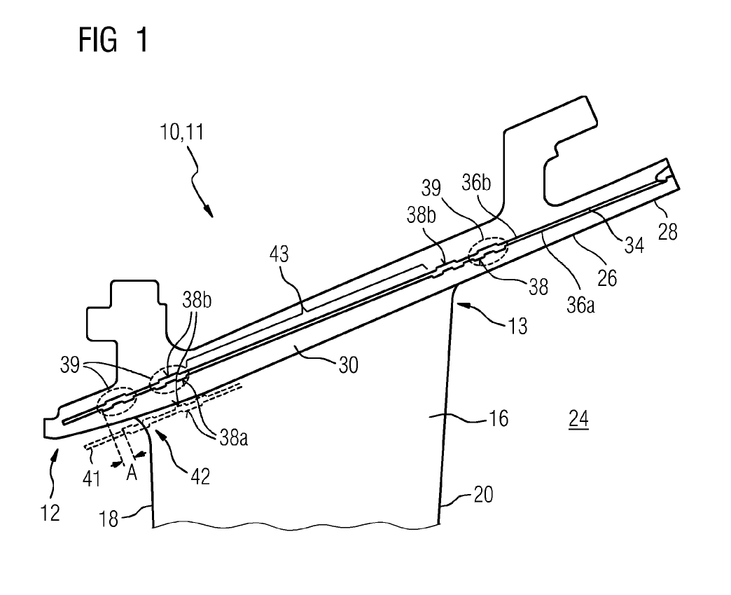

FIG. 1 shows, in a side view, a turbine guide blade 11 as a component 10 of a stationary gas turbine. The turbine guide blade 11 comprises a foot-side end 12 and a head-side end (not illustrated specifically), between which an aerodynamically curved airfoil 16 extends. The airfoil 16 itself extends in the spanwise direction from its foot-side end 13 to its head-side end. Transversely with respect thereto, the airfoil 16 extends from an incident flow edge 18 to a rear edge 20. A platform 22 is provided both at the foot-side end 13 and at the head-side end, the platforms bounding a flow path 24, which is arranged in between, for hot gas. For this purpose, each platform 22 has a surface 26 facing the hot gas flow path 24. The surface 26, referred to below as the first surface 26, ends laterally at an edge 28. Said edge 28 can be designed, as illustrated, as a border. The edge 28 is adjoined by a second surface 30 which is oriented transversely with respect to the first surface 26. If the edge 28 is not designed as a border, but rather as a radius, the first and the second surface 26, 30 merge into each other.

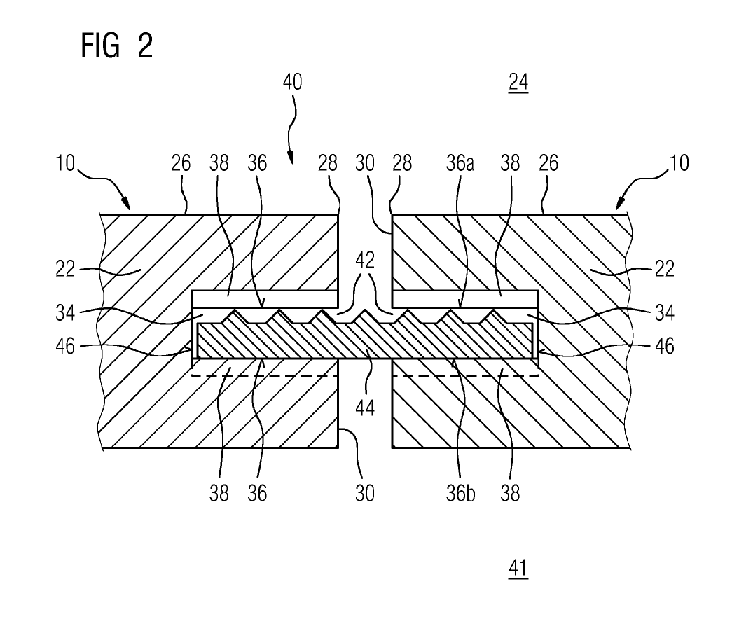

When the turbine guide blade which is shown is used within a gas turbine, a plurality of turbine guide blades 11 arranged in a ring form a series of guide blades, wherein the second surfaces 30 of directly adjacent turbine blades 11 then in each case lie opposite one another forming a gap (FIG. 2). For such arrangements, only those edges 28 of the platforms which, as seen in the circumferential direction, bound the first surface 26 are then relevant.

In order to very substantially seal off the gap bounded by two directly opposite, second surfaces 30 of adjacent turbine blades 10 and to permit a defined leakage, grooves 34 in which a plate-like sealing element 44 is fitted (FIG. 2) are provided in the second surfaces 30. The two components 10 and the sealing element 44 then form a sealing arrangement 40 which prevents the hot gas conducted in the flow path 24 from being able to flow out into other regions 41 located on the far side of the platforms 22. Each groove 34 has two side walls 36. A differentiation can be made here between a first side wall 36a and a second side wall 36b, wherein the first side wall 36a is in each case arranged closer to the first surface 26 or to the edge 28 than the second side wall 36b. Consequently, a hot-gas-side side wall 36a and a cold-gas-side side wall 36b can be discussed. If the discussion below is only about the side wall 36 (without “a” and “b”), the statements made of course apply to each side wall.

Each groove 34 extends along the edge 28, but at a small distance with respect thereto. Groove-shaped recesses 38 are provided in each side wall 36.

The geometry of the groove 34 is first of all explained in more detail below and in conjunction with FIG. 1. Each side wall 36 of the groove 34 has, along its longitudinal extent, from the incident-flow-side end 18 to the outflow-side end 20, a plurality of consecutive recesses 38. Elevations and recesses 38 therefore alternate in the side wall 36a and in the side wall 36b. With respect to the two side walls 36a, 36b, the recesses 38 and the elevations remaining between two recesses 38 are arranged with a small offset, and therefore recesses 38 and elevations can be logically combined to form groups 39—as illustrated by the dashed circles.

The recesses 38 on the side walls 36 of the groove 34 are distributed along the two side walls 36 in such a manner that the steps between recesses 36 and elevations of a side wall 36a (36b) are offset in relation to the steps of the other side wall 36b (36a). In addition, the hot-gas-side recesses 38a are only half as long as the cold-gas-side recesses 38b.

During operation, cooling air flows into the cold-gas-side recesses 38b, and therefore each cold-gas-side recess 38b can supply two hot-gas-side recesses 38a with cooling air, with the sealing element 44 being flowed around. In this respect, a group 39 can be defined by this means.

The groove 34 can, of course, also be used in annular segments which, forming a circle in the circumferential direction, can bound an axial portion of the flow path 24 of the gas turbine radially outside the tips of rotor blades.

In the exemplary embodiment of the groove 34 that is illustrated according to FIG. 2, there are longer groove portions 43 which are free from recesses 38. Grooves 34 of this type are appropriate wherever increased wear phenomena occur only at certain positions of the edge or of the first surface 26.

In addition, FIG. 1 shows, in a dashed type of line, part of a groove 41 which belongs to that component (not shown) which lies opposite the platform 22 of the turbine guide blade 11 illustrated in a manner forming a gap. The depiction of the groove 41 is mirrored with respect to the groove 34, and therefore the hot-gas-side recesses 38a of the groove 41 are illustrated in FIG. 1 above the cold-gas-side recesses 38b.

As can readily be seen from this illustration, the two groups 39 and 42 of the recesses 38 of the two mutually opposite components are offset by a distance A from one another. This permits an arrangement of hot-gas-side recesses 38a that is virtually unbroken along the gap, and therefore particularly good cooling with a defined quantity of cooling air is possible in this region.

FIG. 2 shows, in cross section, the sealing arrangement 40 comprising two components 10, each having a first surface 26 which is intended to bound a flow path 24 of the gas turbine, wherein the first surfaces 26 merge via edges 28 into a second surface 30, which second surfaces 30 are arranged transversely with respect to the first surfaces 26. The grooves 34 running along the edge 28 and in parallel at a distance thereto are arranged in each second surface 30, said grooves being able to have one or more recesses 38 on their side walls 36 along the longitudinal extent of the groove 34. The recesses 38 extend from a groove opening 42, which lies in the second surface 30, as far as a groove base 46 which lies opposite said groove opening 42.

The recesses 38 permit the targeted and metered flow of cooling air from a cold-gas side 48, which lies on the far side of the platforms 22, to a hot-gas side, which lies on this side of the platforms 22, and which platforms bound the flow path 24 of the gas turbine.

Should it be presumed that the production of the grooves 34 according to the invention is more complicated, it can equally be maintained that said grooves can be produced comparatively simply by means of erosion.

Sealing elements 44 are inserted in the grooves 36. Said sealing elements are of flat configuration along their longitudinal extent—i.e. parallel to the edge 28—and therefore have the same material thickness in this direction over their entire longitudinal extent. That is to say, the sealing elements 44 are free from slots or cutouts with which cooling air can be guided in a targeted manner from the cold-gas side 48 to hot-gas side. Nevertheless, sealing tips can be arranged on one or both surfaces of the sealing element 44, which surfaces face the side walls 36, said sealing tips in principle preventing the occurrence of a cooling air flow in those portions of the groove 34 that are not recessed.

1. A component which can be subjected to hot gas for a gas turbine, having at least one wall, the component comprising:
a first surface as far as an edge, wherein the first surface is adapted for delimiting a hot gas flow path of the gas turbine, and
a second surface which adjoins the edge and is arranged transversely with respect to the first surface, wherein a groove for receiving a sealing element is arranged in the second surface and extends at least partially along the edge at a distance from the edge, and
wherein the groove comprises a groove base and two mutually facing side walls which adjoin said groove face and extend along the edge, of which side walls one of the two is arranged on the hot gas side and the other is arranged on the cold gas side and each have recesses,
wherein at least some of the recesses are combined to form a group, the recesses of which are arranged in such a manner that two of said recesses of said group are arranged in the hot-gas-side side wall and are spaced apart from each other in such a manner that a further recess of said group, which recess is arranged in the cold-gas-side side wall, partially lies opposite each of the two hot-gas-side recesses.

2. The component as claimed in claim 1,
wherein each side wall has a plurality of groups of recesses in at least one longitudinal portion of the groove.

3. The component as claimed in claim 2,
wherein the relevant group has a longitudinal extent which is detectable in the longitudinal direction of the groove, and wherein the groove has a region which is free of recesses and the longitudinal extent of which is greater than the longitudinal extent of an individual group.

4. The component as claimed in claim 1,
wherein the component is configured as a turbine blade or as an annular segment.

5. A sealing arrangement comprising
two components, of which at least one in each case is configured as claimed in claim 1,
wherein the two components are arranged in such a manner that the second surfaces thereof lie opposite each other forming a gap and a sealing element is inserted into the mutually opposite grooves thereof for sealing the gap.

6. The sealing arrangement as claimed in claim 5,
wherein the sealing element is configured in the shape of a panel and has sealing teeth on at least one of the two sealing element surfaces facing the side walls of the groove.

7. The sealing arrangement as claimed in claim 5,
wherein in each case at least one group of recesses is provided in each of the mutually opposite grooves said recesses being offset with respect to one another at least partially along the groove extent.
